(19) United States
(12) Patent Application Publication
(10) Pub. No.: US 2026/0070225 A1
(43) Pub. Date: Mar. 12, 2026

(54) VISUAL CHAIN-OF-THOUGHT REASONING FOR ROBOT VISION-LANGUAGE-ACTION MODELS

(71) Applicant: NVIDIA Corporation, Santa Clara, CA (US)

(72) Inventors: Qingqing Zhao, Palo Alto, CA (US); Donglai Xiang, San Jose, CA (US); Qianli Ma, Zürich (CH); Ankur Handa, Seattle, WA (US); Yao Lu, Palo Alto, CA (US); Tsung-Yi Lin, Sunnyvale, CA (US); Ming-Yu Liu, Redwood City, CA (US); Zhaoshuo Li, Santa Clara, CA (US)

(21) Appl. No.: 19/049,354

(22) Filed: Feb. 10, 2025

Related U.S. Application Data
(60) Provisional application No. 63/691,529, filed on Sep. 6, 2024.
(60) Provisional application No. 63/720,549, filed on Nov. 14, 2024.

(51) Int. Cl. B25J 9/16; G06V 10/82

(52) U.S. Cl. CPC B25J 9/1697; B25J 9/161; B25J 9/163; G06V 10/82

(57) ABSTRACT

Apparatuses, systems, and techniques are disclosed for controlling a robot to execute a task. In at least one embodiment, a current image of the robot in an environment and a text describing the task are obtained. A future image of the robot in the environment is predicted based on the current image and the text. Subsequently, one or more actions are predicted based on the current image, the future image, and the text. The one or more actions can move the robot from a first state corresponding to the current image to a second state corresponding to the future image. The robot executes the sequence of actions to move in the environment.

### CLAIM OF PRIORITY

This application claims the benefit of U.S. Provisional Application No. 63/691,529 titled “Video-Language-Action Foundation Model for Robotics,” filed Sep. 6, 2024, and U.S. Provisional Application No. 63/720,549 titled “Video-Language-Action Foundation Model for Robotics,” filed Nov. 14, 2024, the entire contents of which are incorporated herein by reference.

### BACKGROUND

Vision-Language-Action (VLA) models have shown potential in leveraging pretrained vision-language models and diverse robot demonstrations for learning generalizable sensorimotor control. While this paradigm effectively utilizes large scale data from both robotic and non-robotic sources, current VLA models primarily focus on direct input-output mappings, lacking the intermediate reasoning steps crucial for complex manipulation tasks. As a result, existing VLA models lack temporal planning or reasoning capability.

### SUMMARY

Embodiments of the present disclosure relate to visual chain-of-thought (CoT) reasoning for Vision-Language-Action (VLA) models. Systems and methods are disclosed that incorporate visual CoT reasoning into VLA models to predict future image frames auto-regressively as visual subgoals, and generating a short action sequence to achieve these subgoals.

### BRIEF DESCRIPTION OF THE DRAWINGS

The present systems and methods for visual chain-of-thought reasoning for Vision-Language-Action (VLA) models are described in detail below with reference to the attached drawing figures, wherein:

FIG. 1A illustrates a block diagram of a multi-modal system suitable for use in implementing some embodiments of the present disclosure;

FIG. 1B illustrates an example task execution trajectory, in accordance with an embodiment;

FIG. 1C illustrates example task execution trajectories, in accordance with an embodiment;

FIG. 2A illustrates a flowchart of a method for executing a robotic manipulation task, in accordance with an embodiment;

FIG. 2B illustrates a closed-loop control example of a robot executing a robotic manipulation task, in accordance with an embodiment;

FIG. 3A illustrates a flow diagram of a framework, in accordance with an embodiment;

FIG. 3B is a matrix illustrating a hybrid attention mechanism, in accordance with an embodiment;

FIG. 3C illustrates a flow diagram of a framework, which controls a robotic system to execute a closed-loop control scheme, in accordance with an embodiment;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

Systems and methods are disclosed herein that relate to visual chain-of-thought (CoT) reasoning for Vision-Language-Action (VLA) models, and in particular, to the incorporation of visual CoT through subgoal image generation as an intermediate reasoning step for robotic control, thereby enabling robots to “think visually” about how to accomplish a task before acting.

In at least one embodiment, a multi-modal system is provided comprising a subgoal predictor and an action predictor, which are sequentially arranged. The multi-modal system receives visual data representing the observation of the current state and text data defining a robotic manipulation task as input. Based on the input, the multi-modal system first predicts a subgoal representation in visual data corresponding to a possible future state of the robot. The multi-modal system then predicts a sequence of actions that can move the robot from the current state to the subgoal future state.

In at least one embodiment, a VLA model is provided that is capable of processing both textual and visual data using an LLM. The VLA model receives an observation image corresponding to the current state and a text instruction describing the robotic manipulation task as input. The input image and text are first encoded (and/or projected) to provide current visual tokens and text tokens in a textual embedding space. The VLA model predicts future visual tokens based on the current visual tokens and the text tokens. The future visual tokens are decoded to generate a subgoal image. The VLA model further predicts a sequence of action tokens based on the current visual tokens, the text tokens, and the future visual tokens.

In at least one embodiment, a VLA model is provided that utilizes a hybrid attention mechanism for the token prediction at different stages. For example, the VLA model applies causal attention for predicting future visual tokens and then uses full attention for predicting action tokens.

Systems and methods are disclosed herein that, by incorporating a VLA model capable of subgoal image generation—facilitated by a LLM, enable a robot to “think visually” through CoT reasoning before acting. This approach enhances the reasoning capabilities and action prediction performance of VLA models while also enabling the use of more flexible training data for model training. Subgoal images can be used as intermediate reasoning steps, and their generation does not require action annotations. As a result, existing information in robot manipulation data can be leveraged with minimal processing required. Furthermore, as action annotations are not required in subgoal image generation, abundant video data can be used for model training, leading to improved visual reasoning and understanding. For example, both dynamics and instruction following can be learned from captioned videos, which are significantly more abundant than robot demonstrations. Therefore, as compared to prior art techniques that rely on robot demonstration data (with action annotations) to train VLA models (which can present challenges in terms of both dataset availability and computational burden required for processing image data), the incorporation of a VLA model with subgoal image generation capability allows a broader range of data to be utilized for model training.

A method is provided for controlling a robot to execute a task, which includes obtaining a current image of the robot in an environment and text describing the task, the current image corresponding to a first state of the robot, predicting, based on the current image and the text, a future image of the robot in the environment, the future image corresponding to a second state of the robot, predicting, based on the current image, the future image, and the text, one or more actions for manipulating the robot from the first state to the second state, and executing, by the robot, the one or more actions to move the robot from the first state toward the second state.

According to an embodiment of the method, the method further includes after executing the one or more actions, obtaining a second current image of the robot in the environment, the second current image corresponding to a third state of the robot, predicting, based on the second current image and the text, a second future image of the robot in the environment, the second future image corresponding to a fourth state of the robot, predicting, based on the second current image, the second future image, and the text, one or more second actions for manipulating the robot from the third state to the fourth state, and executing, by the robot, the one or more second actions to move the robot from the third state toward the fourth state.

According to an embodiment of the method, the method further includes predicting a sequence of additional future images and corresponding actions for iteratively moving the robot to cause the robot to complete the task.

According to an embodiment of the method, the predicting the future image of the robot and the predicting the one or more actions are performed by a Vision-Language-Action (VLA) model configured to encode the current image to provide a sequence of current visual tokens, encode the text to provide a sequence of text tokens, predict a sequence of future visual tokens based on the sequence of current visual tokens and the sequence of text tokens, predict a sequence of action tokens based on the sequence of current visual tokens, the sequence of text tokens, and the sequence of future visual tokens, and generate the one or more actions by decoding the sequence of action tokens.

According to an embodiment of the method, the VLA is configured to predict the sequence of future visual tokens based on the sequence of current visual tokens and the sequence of text tokens by using causal attention, and predict the sequence of action tokens based on the sequence of current visual tokens, the sequence of text tokens, and the sequence of future visual tokens by using full attention.

According to an embodiment of the method, the VLA model is trained during a pre-training phase, to predict future images based on current images and text by minimizing a loss between visual features in predicted future images and visual features in ground truth images provided in a training dataset and by minimizing a cross-entropy loss for action predictions. In at least one embodiment, the VLA model is trained, during an adaptation phase, for downstream closed-loop deployment by using task-specific robot demonstration data collected from setups of a target robot.

According to an embodiment of the method, the training dataset includes robot demonstration data annotated with actions and robot states, and action-less videos annotated with only robot states.

According to an embodiment of the method, the VLA model also includes a Large Language Model (LLM) configured to: (i) predict a sequence of intermediate visual tokens based on the sequence of current visual tokens and the sequence of text tokens, and (ii) predict the sequence of action tokens based on the sequence of current visual tokens, the sequence of text tokens, and the sequence of future visual tokens, a vision encoder, a projector, and a depth transformer configured to: (i) predict, through autoregression, residual tokens corresponding to the sequence of intermediate visual tokens, and (ii) combine the residual tokens with the sequence of intermediate visual tokens output to provide the sequence of future visual tokens.

According to an embodiment of the method, the current image represents a current state of the robot in pixel space, and wherein the future image represents a planned state of the robot in pixel space.

A machine-readable medium is provided having stored thereon a set of instructions, which if performed by one or more processors, cause the one or more processors to perform the method for controlling a robot to execute a task.

A system is provided for controlling a robot to execute a task, which includes one or more processors configured to: obtain a current image of the robot in an environment and text describing the task, the current image corresponding to a first state of the robot, predict, based on the current image and the text, a future image of the robot in the environment, the future image corresponding to a second state of the robot, predict, based on the current image, the future image, and the text, one or more actions for manipulating the robot from the first state to the second state, and execute, by the robot, the one or more actions to move the robot from the first state toward the second state.

According to an embodiment of the system, the one or more processors are further configured to: after executing the one or more actions, obtain a second current image of the robot in the environment, the second current image corresponding to a third state of the robot, predict, based on the second current image and the text, a second future image of the robot in the environment, the second future image corresponding to a fourth state of the robot, predict, based on the second current image, the second future image, and the text, one or more second actions for manipulating the robot from the third state to the fourth state, and execute, by the robot, the one or more second actions to move the robot from the third state toward the fourth state.

According to an embodiment of the system, the one or more processors are further configured to: predict a sequence of additional future images and corresponding actions for iteratively moving the robot to cause the robot to complete the task.

According to an embodiment of the system, the predicting the future image of the robot and the predicting the one or more actions are performed by a Vision-Language-Action (VLA) model configured to: encode the current image to provide a sequence of current visual tokens, encode the text to provide a sequence of text tokens, predict a sequence of future visual tokens based on the sequence of current visual tokens and the sequence of text tokens, predict a sequence of action tokens based on the sequence of current visual tokens, the sequence of text tokens, and the sequence of future visual tokens, and generating the one or more actions by decoding the sequence of action tokens.

According to an embodiment of the system, the VLA model is configured to: predict the sequence of future visual tokens based on the sequence of current visual tokens and the sequence of text tokens by using causal attention, and predict the sequence of action tokens based on the sequence of current visual tokens, the sequence of text tokens, and the sequence of future visual tokens by using full attention.

According to an embodiment of the system, the VLA model is trained, during a pre-training phase, to predict future images based on current images and text by minimizing a loss between visual features in predicted future images and visual features in ground truth images provided in a training dataset and by minimizing a cross-entropy loss for action predictions. In at least one embodiment, the VLA model is trained, during an adaptation phase, for downstream closed-loop deployment by using task-specific robot demonstration data collected from setups of a target robot.

According to an embodiment of the system, the training dataset includes robot demonstration data annotated with actions and robot states, and action-less videos annotated with only robot states.

According to an embodiment of the system, the VLA model includes a Large Language Model (LLM) configured to: (i) predict a sequence of intermediate visual tokens based on the sequence of current visual tokens and the sequence of text tokens, and (ii) predict the sequence of action tokens based on the sequence of current visual tokens, the sequence of text tokens, and the sequence of future visual tokens, a vision encoder, a projector, and a depth transformer configured to: (i) predict, through autoregression, residual tokens corresponding to the sequence of intermediate visual tokens, and (ii) combine the residual tokens with the sequence of intermediate visual tokens output to provide the sequence of future visual tokens.

According to an embodiment of the system, the current image represents a current state of the robot in pixel space, and wherein the future image represents a planned state of the robot in pixel space.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

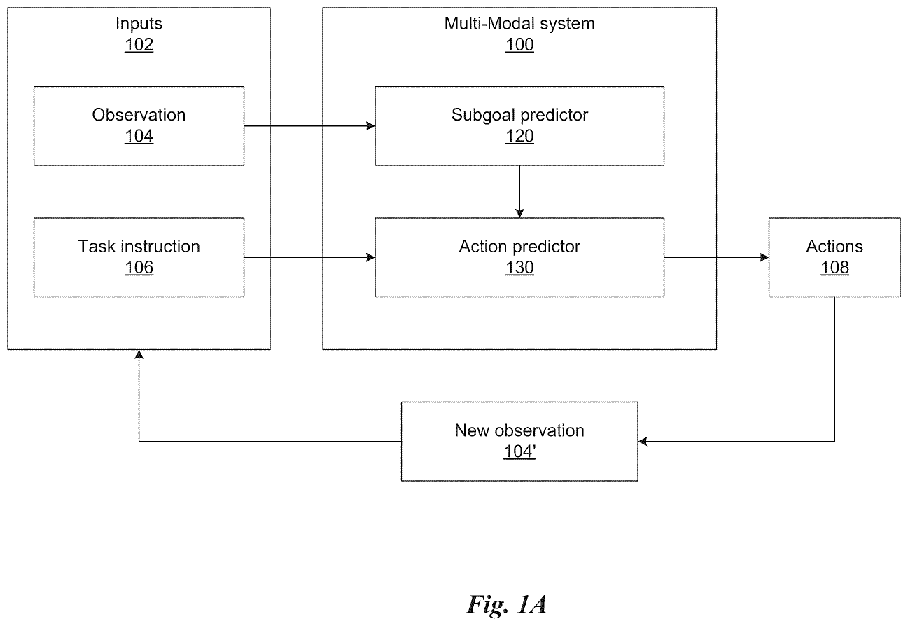

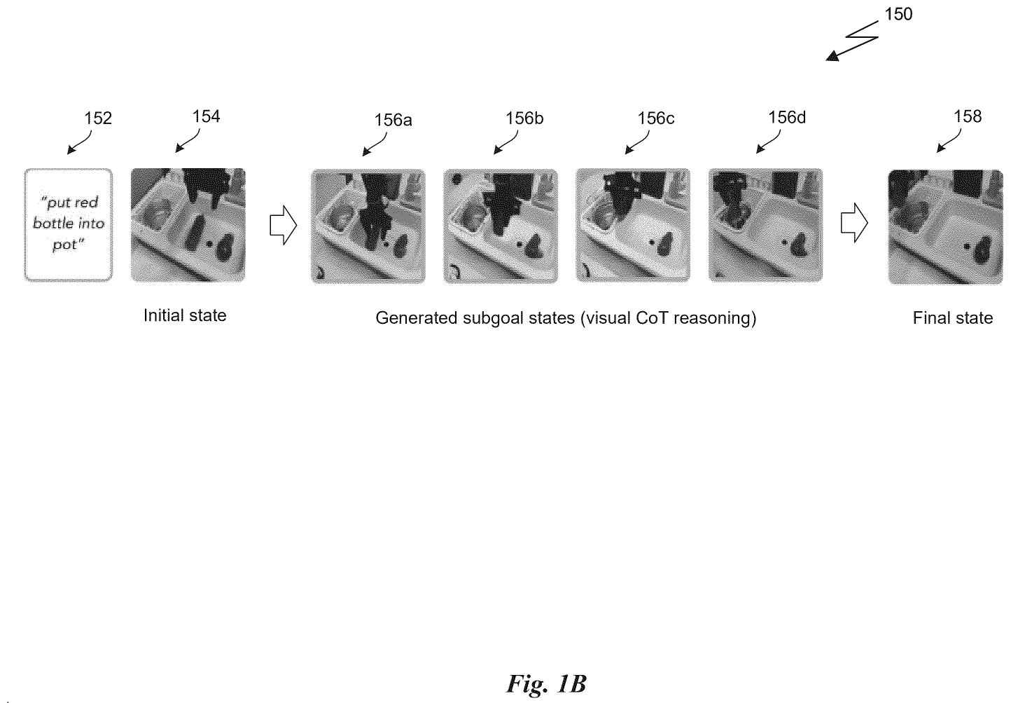

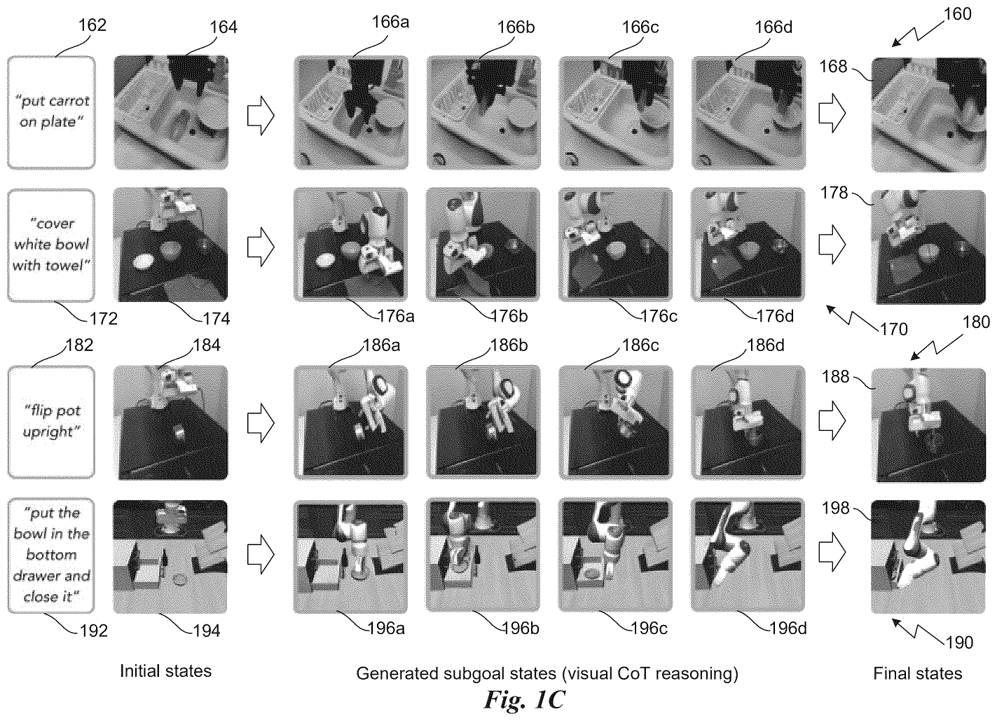

FIG. 1A illustrates a block diagram of a multi-modal system 100 according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the multi-modal system 100 is within the scope and spirit of embodiments of the present disclosure.

The multi-modal system 100 includes a subgoal predictor 120 and an action predictor 130 to implement functions disclosed herein. The multi-modal system 100 is configured to process an input 102 and outputs a set of actions for robotic manipulation tasks. It will be noted that the subgoal predictor 120 and the action predictor 130 can be integrated in a single functional module or operate as separate functional modules that cooperate with each other. In at least one embodiment, the subgoal predictor 120 and the action predictor 130 are integrated into a neural network comprising a plurality of layers. For example, the subgoal predictor 120 is associated with one or more layers in the plurality of layers in the neural network, while the action predictor 130 is associated with one or more different layers in the network.

The input 102 includes an observation 104 of a robot in an environment and a task instruction 106. In at least one embodiment, the observation 104 includes visual data, such as one or more images (e.g., from various perspective views) and/or a video, showing the robot (or a portion of it) in the environment, such as an end-effector positioned in a workplace. In at least one embodiment, the visual data can include a composite image that combines the one or more images or one or more image frames from the video. The task instruction 106 describes a robotic manipulation task in natural language. In at least one embodiment, the task instruction 106 includes a high-level text prompt, such as “pick up a carrot.” However, it will be noted that the task instruction 106 can include text descriptions with varying levels of details, and/or can be derived from other forms of input, such as audio input.

The subgoal predictor 120 processes the input 102 to predict a future observation representation. The subgoal predictor 120 includes one or more layers in a network.

In at least one embodiment, the multi-modal system 100 includes a text encoder to generate a sequence of text tokens based on the task instruction 106, a vision encoder (also referred to as a vision tower) to generate a sequence of visual tokens based on the observation 104, and an encoder projector to project the visual tokens into a textual embedding space. It will be noted that one or more of the text encoder, the vision encoder, and/or the encoder projector can be integrated in the subgoal predictor 120 and/or operate as a separate network(s).

The subgoal predictor 120 utilizes a large language model (LLM) to process the sequence of text tokens and the sequence of visual tokens corresponding to the current observation (e.g., the observation 104), to generate a sequence of future visual tokens. The LLM is trained to perform visual reasoning and understanding based on the input visual tokens and text tokens, generating one or more predicted visual tokens that correspond to an intermediate step (e.g., a subgoal) in achieving the final goal defined by the task instruction 106. The multi-modal system 100 projects the sequence of future visual tokens to a feature embedding space, for example using a decoder projector, and uses a vision decoder to decode the sequence of future visual tokens. The vision decoder outputs a predicted visual representation, for example, in pixel space. For example, the predicted visual representation includes a future subgoal image that represents a future state of the robot. It will be noted that the vision decoder and/or the decoder projector can be integrated in the subgoal predictor 120 and/or operate as separate functional module(s).

The action predictor 130 utilizes the LLM (e.g., one or more layers within the LLM) to generate a set of actions to manipulate the robot from the current state (represented by the current observation 104) to the future state (represented by the predicted future visual data). In at least one embodiment, the multi-modal system 100 utilizes the current observation 104 and the predicted observation (e.g., associated with the predicted future visual data) to condition the prediction of actions. In at least one embodiment, the multi-modal system 100 outputs a sequence of actions 108 to manipulate the robot from the current state to the predicted future state.

In at least one embodiment, the multi-modal system 100 can be incorporated in a closed-loop control scheme. For example, the robot first executes the sequence of actions 108 output from the multi-modal system 100. After the robot reaches a new state, the multi-modal system 100 obtains a new observation 104′, which is then used, along with the task instruction 106, to predict the next future observation representation and the next sequence of actions.

As such, the multi-modal system 100 predicts the subgoal image as an intermediate reasoning step before action prediction. The subgoal image represents the state of the system's 100 reasoning process. In at least one embodiment, the multi-modal system 100 utilizes a vision-language-action (VLA) model to facilitate the subgoal generation and goal-conditioned imitation learning. Various robot demonstration datasets can be used for training the multi-modal system 100 to enhance the CoT reasoning.

In at least one embodiment, the multi-modal system 100 employs subgoal image generation as a form of CoT reasoning for robotic tasks. The multi-modal system 100 first generates a subgoal image that represents the robot's planned state in pixel space, and then conditions the robot's action on both the current observation and the generated subgoal image. This approach allows the robot to “think visually” about how to accomplish a task before acting. By using the subgoal image as the intermediate reasoning step, information that already exists in robot manipulation data can be leveraged with minimal preprocessing required. Furthermore, since subgoal image generation does not require action annotations, this enables the use of abundant video data to train the system 100 for enhanced visual reasoning and understanding.

FIG. 1B illustrates an example task execution trajectory 150, in accordance with an embodiment. In at least one embodiment, the multi-modal system 100 is implemented in a robotic system to execute the task. As shown in FIG. 1B, the multi-modal system 100 starts with a text instruction 152 and an image 154 representing the initial state and ultimately reaches a final state (represented by the image 158) to complete the task. The multi-modal system 100 iteratively generates subgoal images 156a-156d, each corresponding to a predicted intermediate (or subgoal) state at a specific time point. For example, the multi-modal system 100 first predicts the subgoal image 156a and controls the robot to move to the state corresponding to the subgoal image 156a. After the robot moves to the state corresponding to the image 156a, the multi-modal system 100 predicts the subgoal images 156b and controls the robot to move to the state corresponding to the subgoal image 156b. Similarly, the robot moves to the states corresponding to the subgoal images 156c and 156b, respectively, as predicted by the multi-modal system 100. Finally, the multi-modal system 100 predicts the a subgoal image (e.g., the image 158) corresponding to the final state and moves the robot to the final state.

FIG. 1C illustrates example task execution trajectories 160-190, in accordance with an embodiment. Similarly, the multi-modal system 100 executes tasks 160-190 based on task instructions 162-192 and initial images 164-194, iteratively predicting subgoal images (e.g., 166a-166d, 176a-176d, 186a-186d, and 196a-196d) and moving the robot accordingly, ultimately reaching the final states corresponding to images 168a-198d, respectively.

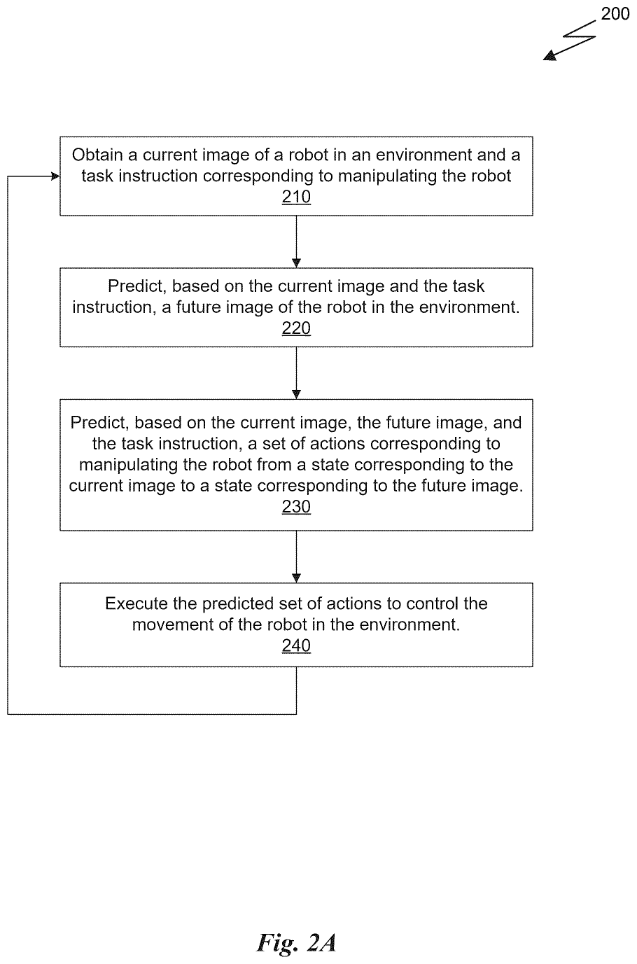

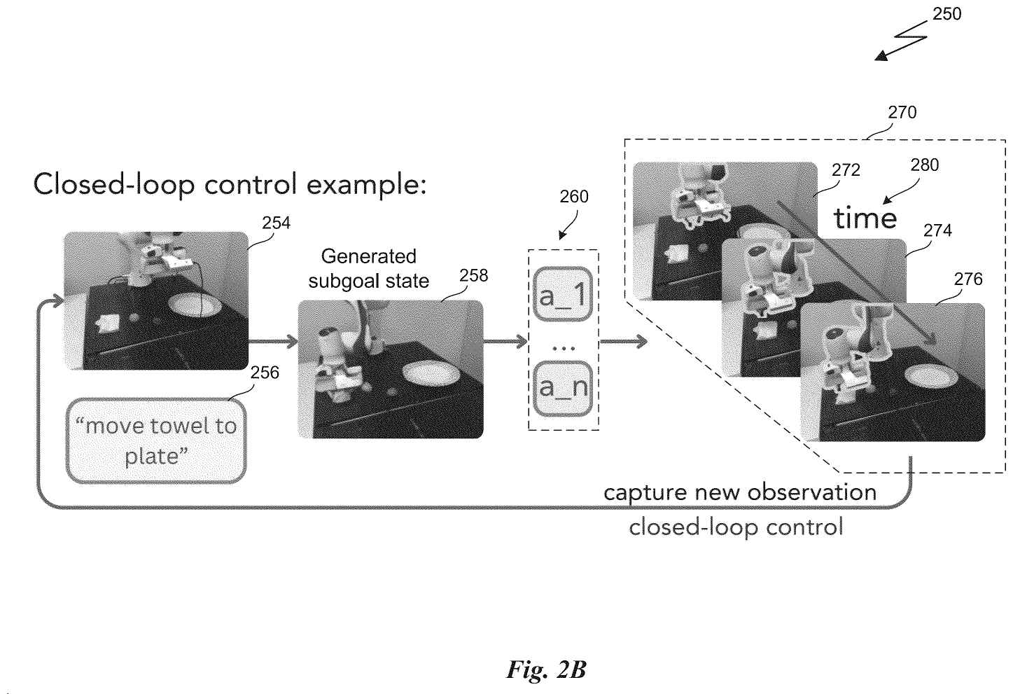

FIG. 2A illustrates a flowchart of a method 200 for executing a robotic manipulation task according to at least one embodiment. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 200 is described, by way of example, with respect to the system 100 of FIG. 1A. However, method 200 may additionally or alternatively be executed by any one system, or any combination of systems, including, but not limited to, those described herein. Furthermore, persons of ordinary skill in the art will understand that any system that performs method 200 is within the scope and spirit of embodiments of the present disclosure. In at least one embodiment, the system 100 is integrated into, or operate in conjunction with a robotic system that includes a robotic arm with one or more joints and an end effector (e.g., a gripper) attached to the end of the robotic arm.

At stage 210, the system 100 obtains a current image of the robot in an environment and a task instruction for manipulating the robot. The environment may include a scene. The observation 104 of the robot in the environment is represented by image data. In at least one embodiment, the image is captured by an imaging device (e.g., a camera) positioned in the environment (e.g., with a fixed/adjustable viewing angle) or mounted on the robot (e.g., with a dynamic viewing angle). The task instruction (e.g., 106) defines a goal for manipulating the robot, such as picking up an object, moving the robot to a designated location, and more. In at least one embodiment, the task instruction is expressed in natural language. The task instruction can be provided via user input. However, it will be noted that the task instruction, expressed in natural language, can also be obtained through other suitable input methods, such as audio input.

In at least one embodiment, the observation 104, such as the image input, captures only a portion of the robot. For example, the observation 104 captures an end effector (e.g., a gripper) in the environment. The system 100 evaluates the state of the robot in the end effector space, for example, describing the robotic state with a multi-dimensional representation that corresponds specifically to the end effector. In at least one embodiment, the state of the end-effector is represented by a seven-dimensional vector including position, orientation, and/or other suitable parameters of the end-effector.

At stage 220, the system 100 predicts, based on the current image and the task instruction, a future image of the robot in the environment. In at least one embodiment, the system 100 first encodes the current image and the task instruction to generate current visual tokens and text tokens, respectively. Then, the system 100 predicts future visual tokens based on the current visual tokens and text tokens. The system 100 can decode the predicted future visual tokens to generate visual data in pixel form, such as a future subgoal image.

At stage 230, the system 100 predicts, based on the current image, the future image, and the task instruction, a set of actions corresponding to manipulating the robot from a state corresponding to the current image to a state corresponding to the future subgoal image. In at least one embodiment, the set of actions include a sequence of actions to move the robot (or its end effector) from the state depicted in the current image to the state depicted in the future subgoal image. In at least one embodiment, the system 100 utilizes the current image and the subgoal image as conditions for the prediction of the actions.

At stage 240, the system 100 executes the predicted set of actions to control the movement of the robot in the environment.

The system 100 can repeat stages 210 through 240 to move the robot iteratively until the robot completes the task defined in the task instruction.

FIG. 2B illustrates a closed-loop control example 250 of a robot executing a robotic manipulation task, in accordance with an embodiment. In at least one embodiment, the robot implements the multi-modal system 100 as depicted in FIG. 1A, to perform the method 200 as illustrated in FIG. 2A to execute the robotic manipulation task.

As shown in FIG. 2B, the task instruction 256 is “move towel to plate.” The robot is instructed to manipulate the robot according to the task instruction 256 from an initial state represented by an input image 254. The robot first predicts a subgoal state image 258 as an intermediate goal (or a subgoal) towards an ultimate goal defined by the task instruction 256. Based on the generated subgoal state image 258, the robot predicts a sequence of actions 260, denoted as (a₁, . . . , aₙ), which can guide the robot's movement from the current state to the predicted subgoal state. For example, the execution of the sequence of actions is represented by the observation images 272, 274, and 276 along the timeline 280, as shown within the dashed pentagon 270. After executing the sequence of actions 260, the robot obtains the new observation (e.g., the image 276) and repeats the previous stages until the manipulation task is completed.

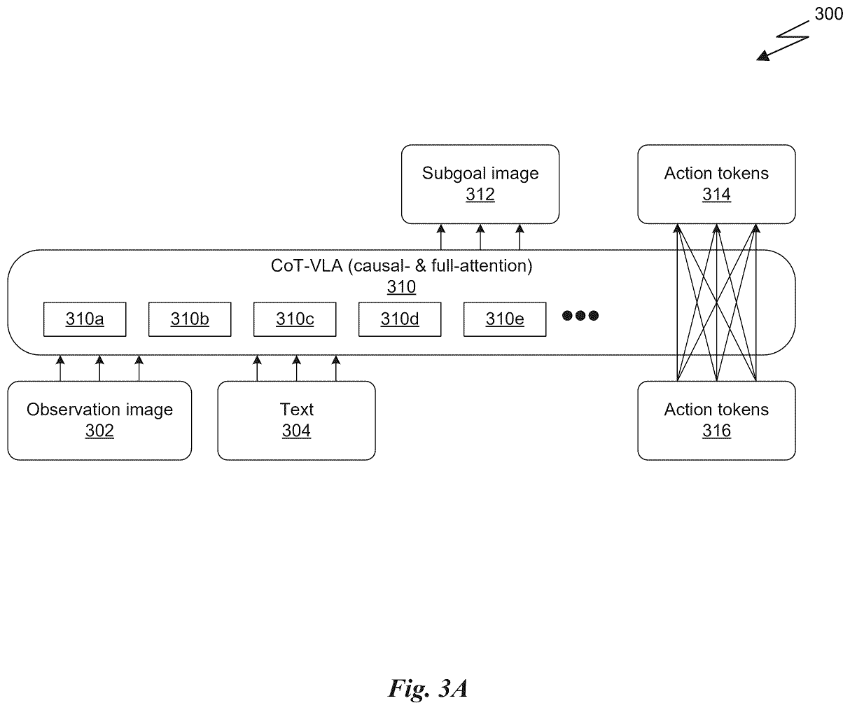

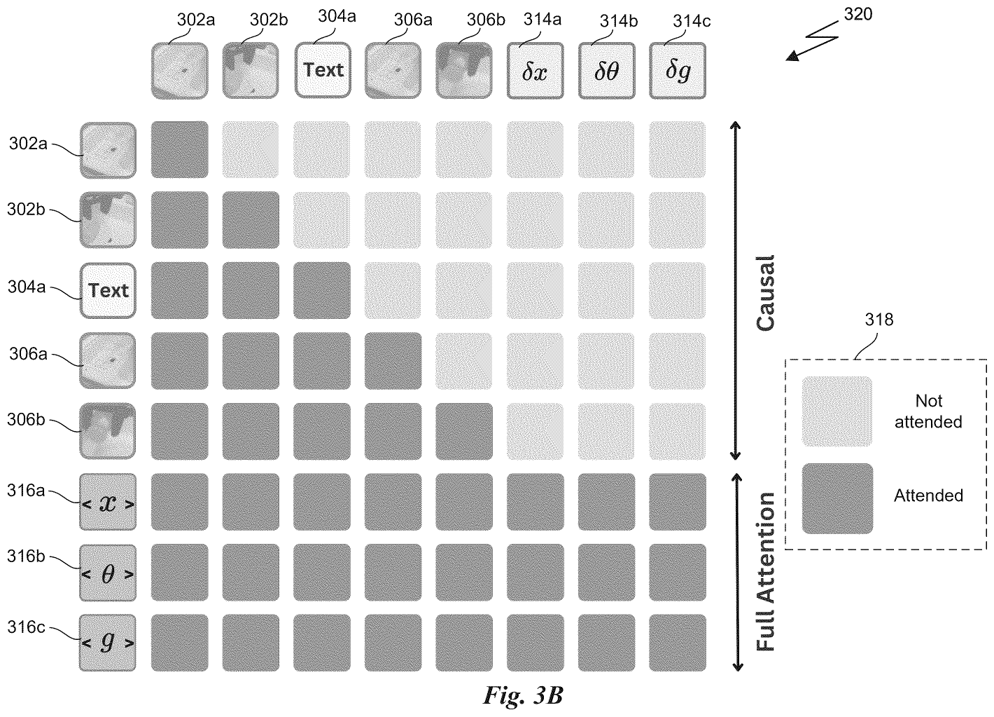

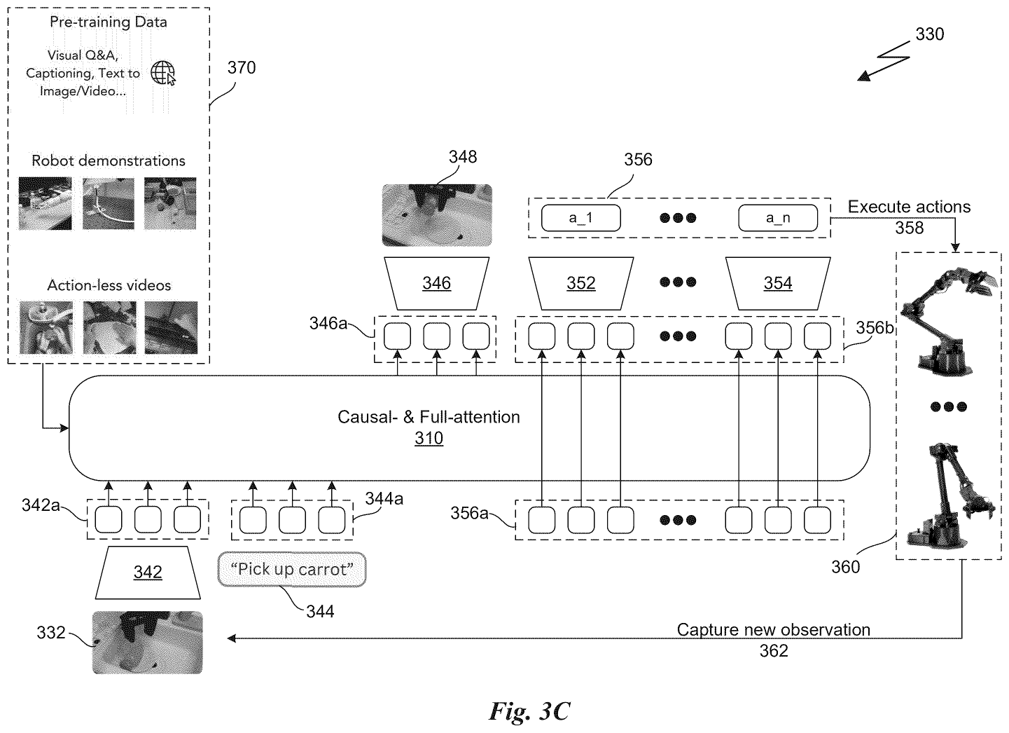

FIG. 3A illustrates a flow diagram of a framework 300, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the framework 300 is within the scope and spirit of embodiments of the present disclosure. In at least one embodiment, the framework 300 is integrated in the multi-modal system 100 as depicted in FIG. 1A, and/or utilized to perform the method 200 as depicted in FIG. 2A.

The framework 300 utilizes a VLA model capable of processing both textual and visual data using an LLM. The VLA model is configured to perform visual CoT reasoning, and is referred to as a CoT-VLA model 310 in this example. The CoT-VLA model 310 iteratively processes input visual information, leveraging the step-by-step reasoning capabilities of the LLM. This enables visual CoT reasoning, which guides action generation based on the predicted future outcome/state. In at least one embodiment, the CoT-VLA model 310 predicts subgoal images as intermediate reasoning steps for closed-loop action generation. This approach leverages demonstration videos as natural intermediate reasoning states during training without requiring additional annotations.

Referring to FIG. 3A, input to the CoT-VLA model 310 includes an observation image 302 and a text instruction 304. The CoT-VLA model 310 predicts a subgoal image 312 based on the observation image 302 and the text 304. In at least one embodiment, the CoT-VLA model 310 utilizes causal attention for visual and text token generation. At the next stage, the CoT-VLA model 310 predicts a set of actions 314 based on input tokens 316 using full attention.

In at least one embodiment, the CoT-VLA model 310 includes a plurality of neural network layers to facilitate functions described with reference to the multi-modal system 100 as depicted in FIG. 1A. For example, in the CoT-VLA model 310, a first set of layers (e.g., in box 310a) is configured to encode and/or project visual data, a second set of layers (e.g., in box 310b) is configured to encode textual data, a third set of layers (e.g., in box 310c) is configured to decode one or more visual tokens to generate a predicted image (e.g., a subgoal image 312), a fourth set of layers (e.g., in box 310d) includes a depth transformer, a fifth set of layers (e.g., in box 310e) is configured to predict appropriate tokens based on input tokens, along with other suitable layers. In at least one embodiment, the fifth set of layers includes an LLM. The LLM is configured to process image and/or text tokens using causal attention and action tokens using full attention.

In at least one embodiment, a vision encoder/tower (e.g., the first set of layers) in the CoT-VLA model 310 incorporates a depth transformer to improve the representational capacity of discrete visual features. The depth transformer processes the code embeddings of visual tokens generated by the LLM and autoregressively predicts D number of additional residual tokens. The final visual representation (e.g., the future visual tokens for generating the subgoal image 312) is created by summing the D residual tokens with the original code embeddings of the visual tokens generated by the LLM. This approach enhances the future visual tokens provided by the CoT-VLA model 310.

FIG. 3B is a matrix 320 illustrating a hybrid attention mechanism, in accordance with at least one embodiment. The hybrid attention mechanism includes a causal attention stage and a full attention stage, incorporated in the CoT-VLA model 310 as illustrated in FIG. 3A.

As shown in FIG. 3B, the matrix 320 demonstrates the causal attention in the stage of predicting future image tokens 306a and 306b, and the full attention in the stage of predicting action tokens 316a, 316b, 316c, 314a, 314b, and 314c. Blocks 302a and 302b represent visual tokens corresponding to the input image 302, while block 304a represents text token corresponding to the input text 304. The action tokens 316a, 316b, and 316c include [x] tokens, [θ] tokens, and [g] tokens, where [x] tokens encode position or state of the robot (or its end effector), [θ] tokens encode angle or orientation of the robot (or its end effector), [g] tokens encode the goal state or goal position (associated with the predicted subgoal image) of the robot (or its end effector). The action tokens 314a, 314b, and 314c are represented by [δx] tokens, [δθ] tokens, and [δg] tokens, where [δx] tokens refers to the change in position of the robot (or its end effector) in space, [δθ] tokens refers to the change in orientation or angle of the robot (or its end effector), [δg] tokens refers to the change in the goal state or target position of the robot (or its end effector).

It should be noted that the number of tokens for each category is presented for illustration purposes only and should not be considered limiting. As indicated in the legend 318, the dark blocks in the matrix 320 represent the existence of attention between tokens, while the light blocks indicate the absence of attention between tokens.

At the causal attention stage, the CoT-VLA model 310 sequentially outputs tokens 302a, 302b, 304a, 306a, and 306b, with the current token attending only to previously generated tokens. As such, the future image tokens 306a and 306b are predicted based on the current visual tokens 302a and 302b and the text token 304a. At the full attention stage, the CoT-VLA model 310 obtains the action tokens 316a, 316b, 316c, 314a, 314b, and 314c by attending to all the tokens, both those generated earlier (e.g., tokens 302a, 302b, 304a, 306a, and 306b) and those to be generated later (e.g., the action tokens 316a, 316b, 316c, 314a, 314b, and 314c). However, it will be noted that, in various embodiments, other attention mechanisms can be applied. For example, both prediction stages can utilize full attention.

As discussed above, the CoT-VLA model 310 operates in two sequential phases, which can be formulated as:

$${\hat{s}}_{t + n} ∼ {P}_{θ} ( {s}_{t + n} \vert {s}_{t} , l ) \qquad ( Eq . 1 )$$

$$\{ {\hat{a}}_{t} , … , {\hat{a}}_{t + m} \} ∼ {P}_{θ} ( a \vert {s}_{t} , l , {\hat{s}}_{t + n} ) , \qquad ( Eq . 2 )$$

where l denotes the natural language instruction (e.g., a task instruction 106/304), P_{θ}(⋅|⋅) is the conditional probability which is modeled by the weights θ of the CoT-VLA model 310. The CoT-VLA model 310 predicts a subgoal image (ŝₜ₊ₙ), n frames ahead of the current observation image (denoted by sₜ). Subsequently, the CoT-VLA model 310 generates a sequence of m actions {âₜ, . . . , âₜ₊ₘ} to achieve the subgoal state (ŝₜ₊ₙ).

FIG. 3C illustrates a flow diagram of a framework 330, which controls a robotic system to execute a closed-loop control scheme, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the framework 330 is within the scope and spirit of embodiments of the present disclosure. In at least one embodiment, the framework 330 is integrated in the multi-modal system 100 as depicted in FIG. 1A, and/or utilized to perform the method 200 as depicted in FIG. 2A. In at least one embodiment, the framework 330 incorporates part or all of the framework 300, as illustrated in FIG. 3A, to facilitate the functions disclosed therein.

The framework 330 illustrates operations performed during both the training and inference stages. In this example, the CoT-VLA model 310, as depicted in FIG. 3A, is used to process input visual and text data, predicting subgoal images and action sequences. Certain components, such as a vision tower 342, layers for encoding the text input 344, a vision decoder 346, and action decoders 352 through 354, are presented separately from the main body 310, which includes the LLM backbone. This representation is for illustrative purposes only. It should be noted that some or all of these components can be integrated into the CoT-VLA model 310.

Referring the FIG. 3C, the vision tower 342 encodes a current observation 332 to provide a sequence of current visual tokens 342a aligned with textual information. This enables auto-regressive image and video generation while significantly enhancing the understanding capabilities of the VLM that leverage discrete visual features. A text input 344 is encoded into a sequence of text tokens 344a. The CoT-VLA model 310 sequentially processes the sequence of current visual tokens 342a and the sequence of text tokens 344a, applying the causal attention mechanism as illustrated in FIG. 3B. Through this approach, the CoT-VLA model 310 predicts a sequence of future visual tokens 346a based on the current visual tokens 342a and the sequence of text tokens 344a. A subgoal image 348 is generated by decoding the sequence of future visual tokens 346a using a decoder 346. In the next stage, the CoT-VLA model 310 predicts action token sequences (e.g., action tokens 356a and 356b) corresponding to a sequence of actions (a₁ . . . aₙ) 356. The action prediction is based on all previously available tokens, along with the action tokens to be predicted, applying a full attention mechanism as demonstrated in FIG. 3B. A set of decoders (e.g., action decoders 352 through 354) are used to decode the sequence of action tokens 356b to provide the sequence of actions 356. As indicated by arrow 358, the robotic system then executes the action sequence 356. A sequence of observation images, shown in dashed box 360, illustrates the progression of executing the action sequence 356. As indicated by arrow 362, after the robotic system completes the action sequence 356, a new observation image is captured and used as the current observation image (e.g., 332) for the next iteration of moving the robotic system towards the final goal defined by the text instruction 344.

In at least one embodiment, the CoT-VLA model 310 utilizes residual quantization to improve the representational capacity of discrete visual features. For example, the CoT-VLA model 310 incorporates a depth transformer to gradually predict the residual tokens. The extracted visual features are then passed through a projector before being processed by the LLM backbone of the CoT-VLA model 310.

In at least one embodiment, a training scheme is employed that enables the CoT-VLA model 310 to “think visually” first and then predict the actions. In at least one embodiment, the CoT-VLA model 310 includes a pretrained network configured to predict a future image based on an input image and a text instruction. The pretrained network can be trained using various pre-training data (as shown in dashed box 370), such as visual Question and Answering (Q&A) datasets, visual data with text captions, multi-modal pairs (e.g., [image, text], [text, image], [video, text], and [text, video]), and more. In at least one embodiment, the CoT-VLA model 310 can include a network trained from scratch using these datasets to predict a future image based on an input image and a text instruction.

In at least one embodiment, the CoT-VLA model 310 is fine-tuned for robotic manipulation tasks through sequential phases (or stages), utilizing two types of training datasets (as shown in dashed box 370). The first dataset includes robot demonstrations, including videos annotated with both robot actions and robot states. The second dataset includes action-less videos, annotated only with robot states. The two sequential phases are referred to as the pre-training phase and the adaption phase.

In at least one embodiment, the robot demonstrations dataset is denoted as Dᵣ, while the action-less videos dataset is denoted as Dᵥ. The robot demonstrations are represented as: Dᵣ={(l, a_{1 . . . T}, s_{1 . . . T})}, where l denotes the natural language instruction, a_{1 . . . T}={a₁, . . . , a_{T}} denotes the sequence of robot actions (corresponding to action annotations), and s_{1 . . . T}={s₁, . . . , s_{T}} denotes the visual observations as a sequence of images (corresponding to state annotations). Action-less videos are represented as: Dᵥ={(l, s_{1 . . . T})}, consisting of the natural language instruction (l) and images without action annotations. In at least one embodiment, images in these training datasets are processed at 256×256 resolution. For visual reasoning, the CoT-VLA model 310 uses subgoal images at future timestep n uniformly sampled from a dataset-specific range [nₗ, nᵤ], where nₗ and nᵤ define the lower and upper bounds of the prediction horizon.

The CoT-VLA model 310 operates in two sequential phases as formulated by Equations 1 and 2. For example, as represented by Equation 1, the CoT-VLA model 310 first predicts a subgoal image (ŝₜ₊ₙ), n frames ahead of the current observation image (sₜ). The CoT-VLA model 310 uses the predicted subgoal image (ŝₜ₊ₙ) as an intermediate visual reasoning step for the action prediction. As such, the CoT-VLA model 310 is enabled to “think visually” by explicitly reasoning about a desired future state before predicting the actions. As represented by Equation 2, the CoT-VLA model 310 generates a sequence of m actions {âₜ, . . . , âₜ₊ₘ} to achieve the subgoal state (ŝₜ₊ₙ).

In the pre-training phase, the CoT-VLA model 310 is trained to improve the visual reasoning step and the action generation step. The visual reasoning step, as formulated by Equation 1, is trained on both the robot demonstrations dataset (Dᵣ) and the action-less videos dataset (Dᵥ). The action generation step, as formulated by Equation 2, is trained on the robot demonstrations dataset (Dᵣ) only.

In at least one embodiment, three components in the CoT-VLA model 310 are optimized during training, including the LLM backbone, projector, and depth transformer, while the vision tower (e.g., 342) is fixed. The training objective comprises two key components: the subgoal image generation with causal attention and the action generation with full attention.

For subgoal image generation, each training sequence is of form (l, sₜ, sₜ₊ₙ), where sₜ₊ₙ represents the ground truth state (or the ground truth image). The CoT-VLA model 310 learns to predict the future image based on the current image and text instruction. In at least one embodiment, the subgoal image (ŝₜ₊ₙ) predicted based on the input (l, sₜ) is compared with the ground truth state (sₜ₊ₙ). For example, loss between visual features in the predicted future image (ŝₜ₊ₙ) and visual features in the ground truth image (sₜ₊ₙ) provided in the training dataset is minimized. In at least one embodiment, at each visual position (j), the depth transformer (denoted as P_{δ}), auto-regressively predicts D residual tokens (kⱼ₁, . . . k_{jD}) based on the LLM-generated code embedding (hⱼ). The training objective for visual tokens is formulated as:

$${ℒ}_{visual} = - {\sum }_{j} {\sum }_{d = 1}^{D} log {P}_{δ} ( {k}_{j , d} \vert {k}_{j , < d} ) , \qquad ( Eq . 3 )$$

where j indexes the positions containing visual tokens.

For action prediction, each training sequence takes the form (l, sₜ, sₜ₊ₙ, aₜ, . . . , aₜ₊ₘ). In at least one embodiment, each action (aᵢ) is represented by seven tokens, with each action dimension independently discretized. In at least one embodiment, each continuous action dimension is mapped into 256 discrete bins, with bin widths determined by uniformly dividing the interval between the 1^{st} and 99^{th} percentiles of the training data's action distribution. In at least one embodiment, the 256 least frequently used tokens in the text tokenizer's vocabulary are repurposed as action bin tokens. The CoT-VLA model 310 employs full attention for processing and predicting action tokens, enabling all action tokens to interact with each other. During training, the cross-entropy loss for action predictions is minimized as:

$${ℒ}_{action} = - {\sum }_{i = 1}^{m} log {P}_{θ} ( {a}_{t} … {a}_{t + m} \vert l , {s}_{t} , {s}_{t + n} , [ a ] … [ a ] ) , \qquad ( Eq . 4 )$$

where [a] represents special tokens for actions, one for each action dimension. In at least one embodiment, each [a] includes seven tokens.

Given a batch of input sequences, the overall training loss combines the action and visual losses:

$$ℒ = {ℒ}_{action} + {ℒ}_{visual} . \qquad ( Eq . 5 )$$

In the adaption phase, the CoT-VLA model 310 is fine-tuned using task-specific robot demonstration data (Dᵣ) collected on the downstream robot setups for robot deployment. During this phase, the LLM backbone, projector, and depth transformer are optimized while keeping the vision tower fixed, maintaining the same training setup as the previous training phase. The resulting model can execute new manipulation tasks based on natural language instructions (l). Algorithm 1 in the Table below describes the robot control at test time.

Algorithm 1 CoT-VLA test-time closed-loop control
$Require : CoT - VLA Model {P}_{θ} , initial state {s}_{0}^{obs} , language instruction l$

| | |
|---|---|
| 0: | t ← 0 |
| 0: | While True do |
| 0: | $Sample {\hat{s}}_{t + n} ∼ {P}_{θ} ( {s}_{t + n} \vert l , {s}_{0}^{obs} )$ |
| 0: | $Sample [ {\hat{a}}_{t} , … , {\hat{a}}_{t + m} ] ∼ {P}_{θ} ( a \vert l , {s}_{0}^{obs} , {\hat{s}}_{t + n} )$ |
| 0: | for j = 0 to m do |
| 0: | Execute âₜ₊ⱼ |
| 0: | end for |
| 0: | t ← t + m |
| 0: | ${s}_{0}^{obs} ← robot observation$ |

### Parallel Processing Architecture

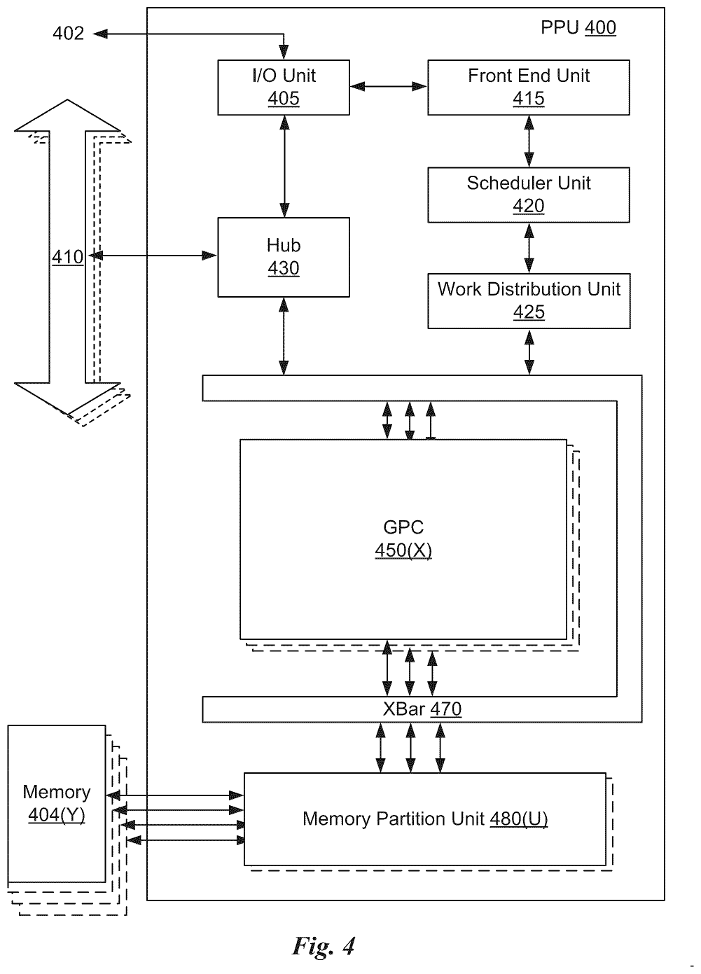

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

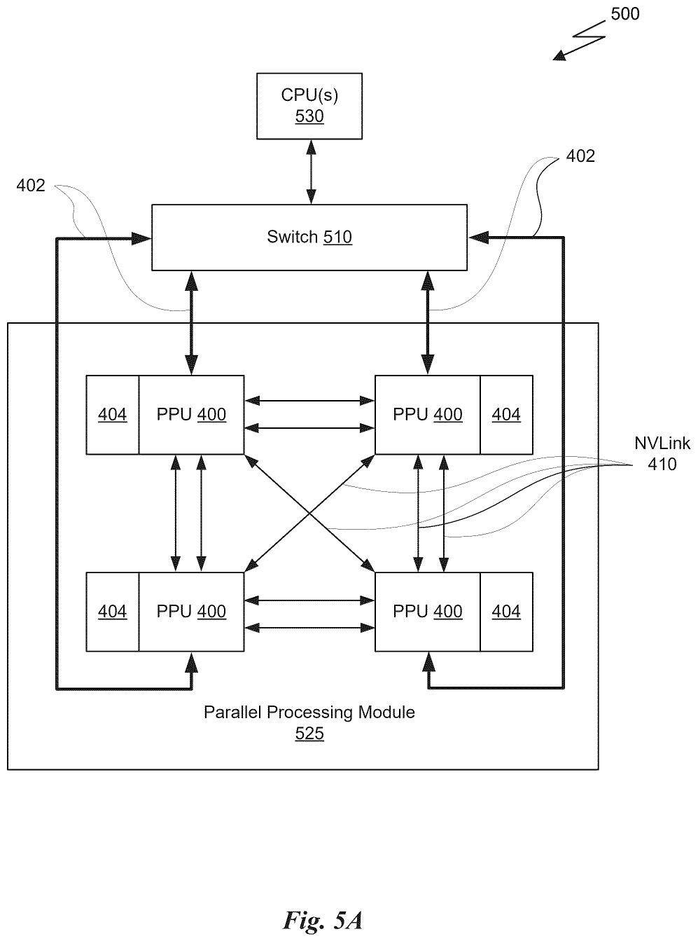

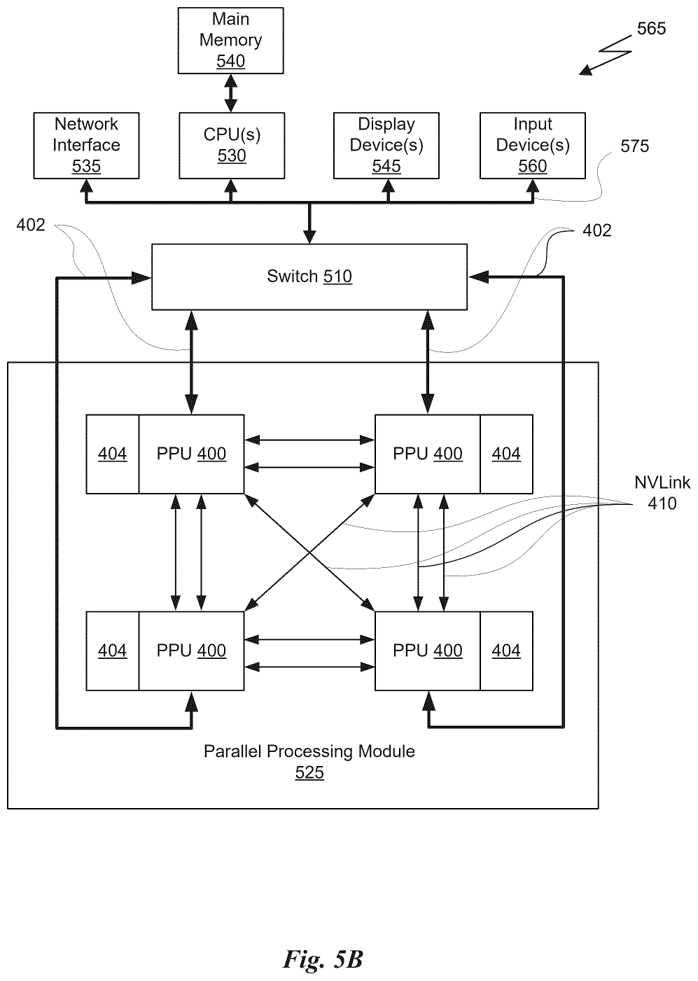

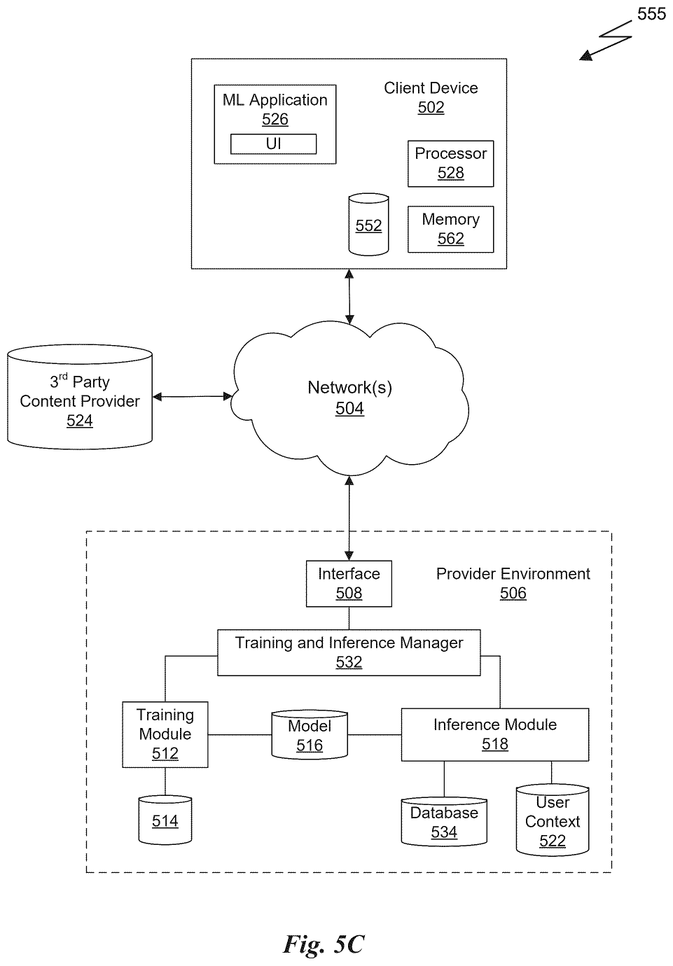

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32-bit, 64-bit, 128-bit, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

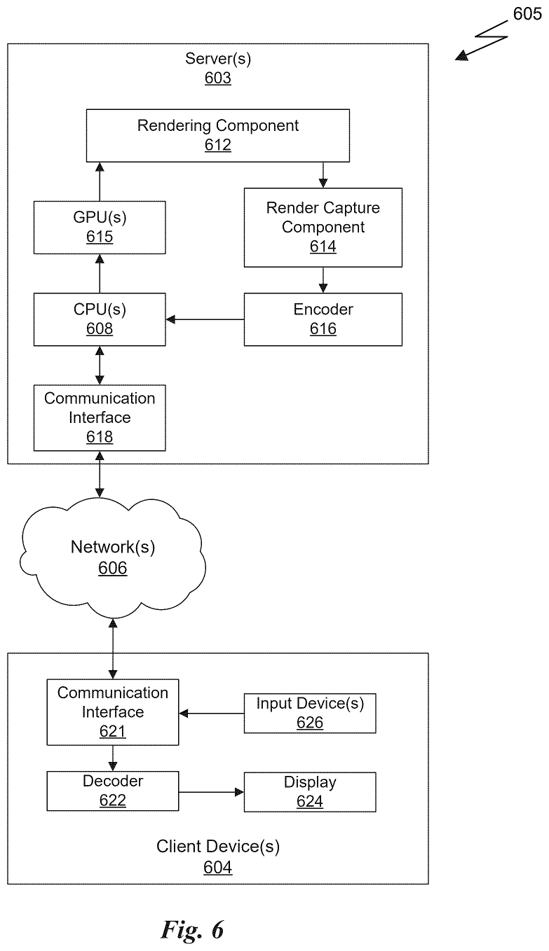

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering—in particular ray or path tracing—for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for controlling a robot to execute a task, the method comprising:
obtaining a current image of the robot in an environment and text describing the task, the current image corresponding to a first state of the robot;
predicting, based on the current image and the text, a future image of the robot in the environment, the future image corresponding to a second state of the robot;
predicting, based on the current image, the future image, and the text, one or more actions for manipulating the robot from the first state to the second state; and
executing, by the robot, the one or more actions to move the robot from the first state toward the second state.

2. The computer-implemented method according to claim 1, further comprising:
after executing the one or more actions, obtaining a second current image of the robot in the environment, the second current image corresponding to a third state of the robot;
predicting, based on the second current image and the text, a second future image of the robot in the environment, the second future image corresponding to a fourth state of the robot;
predicting, based on the second current image, the second future image, and the text, one or more second actions for manipulating the robot from the third state to the fourth state; and
executing, by the robot, the one or more second actions to move the robot from the third state toward the fourth state.

3. The computer-implemented method according to claim 2, further comprising:
predicting a sequence of additional future images and corresponding actions for iteratively moving the robot to cause the robot to complete the task.

4. The computer-implemented method according to claim 1, wherein the predicting the future image of the robot and the predicting the one or more actions are performed by a Vision-Language-Action (VLA) model configured to:
encode the current image to provide a sequence of current visual tokens;
encode the text to provide a sequence of text tokens;
predict a sequence of future visual tokens based on the sequence of current visual tokens and the sequence of text tokens;
predict a sequence of action tokens based on the sequence of current visual tokens, the sequence of text tokens, and the sequence of future visual tokens; and
generate the one or more actions by decoding the sequence of action tokens.

5. The computer-implemented method according to claim 4, wherein the VLA model is configured to:
predict the sequence of future visual tokens based on the sequence of current visual tokens and the sequence of text tokens by using causal attention; and
predict the sequence of action tokens based on the sequence of current visual tokens, the sequence of text tokens, and the sequence of future visual tokens by using full attention.

6. The computer-implemented method according to claim 4, wherein the VLA model is trained, during a pre-training phase, to predict future images based on current images and text by minimizing a loss between visual features in predicted future images and visual features in ground truth images provided in a training dataset and by minimizing a cross-entropy loss for action predictions; and
wherein the VLA model is trained, during an adaptation phase, for downstream closed-loop deployment by using task-specific robot demonstration data collected from setups of a target robot.

7. The computer-implemented method according to claim 6, wherein the training dataset comprises:
robot demonstration data annotated with actions and robot states; and
action-less videos annotated with only robot states.

8. The computer-implemented method according to claim 4, wherein the VLA model comprises:
a Large Language Model (LLM) configured to:
predict a sequence of intermediate visual tokens based on the sequence of current visual tokens and the sequence of text tokens; and
predict the sequence of action tokens based on the sequence of current visual tokens, the sequence of text tokens, and the sequence of future visual tokens;
a vision encoder;
a projector; and
a depth transformer configured to:
predict, through autoregression, residual tokens corresponding to the sequence of intermediate visual tokens; and
combine the residual tokens with the sequence of intermediate visual tokens output to provide the sequence of future visual tokens.

9. The computer-implemented method according to claim 1, wherein the current image represents a current state of the robot in pixel space, and wherein the future image represents a planned state of the robot in pixel space.

10. A system for controlling a robot to execute a task comprising:
one or more processors configured to:
obtain a current image of the robot in an environment and a text describing the task;
predict, based on the current image and the text, a future image of the robot in the environment;
predict, based on the current image, the future image, and the text, one or more actions corresponding to manipulating the robot from a first state corresponding to the current image to a second state corresponding to the future image; and
execute, by the robot, the one or more actions to move the robot in the environment.

11. The system according to claim 10, wherein the one or more processors are further configured to:
after executing the one or more actions, obtain a second current image of the robot in the environment, the second current image corresponding to a third state of the robot;
predict, based on the second current image and the text, a second future image of the robot in the environment, the second future image corresponding to a fourth state of the robot;
predict, based on the second current image, the second future image, and the text, one or more second actions for manipulating the robot from the third state to the fourth state; and
execute the one or more second actions to move the robot from the third state toward the fourth state.

12. The system according to claim 11, wherein the one or more processors are further configured to:
predict a sequence of additional future images and corresponding actions for iteratively moving the robot to cause the robot to complete the task.

13. The system according to claim 10, wherein the predicting the future image of the robot and the predicting the one or more actions are performed by a Vision-Language-Action (VLA) model configured to:
encode the current image to provide a sequence of current visual tokens;
encode the text to provide a sequence of text tokens;
predict a sequence of future visual tokens based on the sequence of current visual tokens and the sequence of text tokens;
predict a sequence of action tokens based on the sequence of current visual tokens, the sequence of text tokens, and the sequence of future visual tokens; and
generate the sequence of actions by decoding the sequence of action tokens.

14. The system according to claim 13, wherein the VLA model is configured to:
predict the sequence of future visual tokens based on the sequence of current visual tokens and the sequence of text tokens by using causal attention; and
predict the sequence of action tokens based on the sequence of current visual tokens, the sequence of text tokens, and the sequence of future visual tokens by using full attention.

15. The system according to claim 13, wherein the VLA model is trained during a pre-training phase, to predict future images based on current images and text, by minimizing a loss between visual features in predicted future images and visual features in ground truth images provided in a training dataset and by minimizing a cross-entropy loss for action predictions; and
wherein the VLA model is trained, during an adaptation phase, for downstream closed-loop deployment by using task-specific robot demonstration data collected from setups of a target robot.

16. The system according to claim 15, wherein the training dataset comprises:
robot demonstration data annotated with actions and robot states; and
action-less videos annotated with only robot states.

17. The system according to claim 13, wherein the VLA model comprises:
a Large Language Model (LLM) configured to:
predict a sequence of intermediate visual tokens based on the sequence of current visual tokens and the sequence of text tokens; and
predict the sequence of action tokens based on the sequence of current visual tokens, the sequence of text tokens, and the sequence of future visual tokens;
a vision encoder;
a projector; and
a depth transformer configured to:
predict, through autoregression, residual tokens corresponding to the sequence of intermediate visual tokens; and
combine the residual tokens with the sequence of intermediate visual tokens output to provide the sequence of future visual tokens.

18. The system according to claim 10, wherein the current image represents a current state of the robot in pixel space, and wherein the future image represents a planned state of the robot in pixel space.

19. A machine-readable medium having stored thereon a set of instructions, which if performed by one or more processors, cause the one or more processors to:
obtain a current image of a robot in an environment and a text describing a task;
predict, based on the current image and the text, a future image of the robot in the environment;
predict, based on the current image, the future image, and the text, one or more actions corresponding to manipulating the robot from a first state corresponding to the current image to a second state corresponding to the future image; and
execute, by the robot, the one or more actions to move the robot in the environment.

20. The machine-readable medium according to claim 19, wherein the one or more processors further perform:
after executing the one or more actions, obtaining a second current image of the robot in the environment, the second current image corresponding to a third state of the robot;
predicting, based on the second current image and the text, a second future image of the robot in the environment, the second future image corresponding to a fourth state of the robot;
predicting, based on the second current image, the second future image, and the text, one or more second actions for manipulating the robot from the third state to the fourth state; and
executing the one or more second actions to move the robot from the third state toward the fourth state.
